(19) United States
(12) Patent Application Publication
(10) Pub. No.: US 2022/0305777 A1
(43) Pub. Date: Sep. 29, 2022

(54) DRIVING WAVEFORM DETERMINING METHOD, LIQUID EJECTING APPARATUS, AND NON-TRANSITORY COMPUTER-READABLE STORAGE MEDIUM STORING COMPUTER PROGRAM

(71) Applicant: Seiko Epson Corporation, Tokyo (JP)

(72) Inventors: Atsushi TOYOFUKU, Shiojiri-shi (JP); Toshiro MURAYAMA, Fujimi-machi (JP)

(21) Appl. No.: 17/656,764

(22) Filed: Mar. 28, 2022

(30) Foreign Application Priority Data
Mar. 29, 2021 (JP) 2021-054948

(51) Int. Cl. B41J 2/045

(52) U.S. Cl. CPC B41J 2/04581; B41J 2/04588

(57) ABSTRACT

A first acquisition processing is processing of acquiring first information indicative of an ejection characteristic of a first liquid ejected by a liquid ejecting device when a driving waveform candidate is applied to a driving element. A second acquisition processing is processing of acquiring second information indicative of an ejection characteristic of a second liquid ejected from the liquid ejecting device when the driving waveform candidate is applied to the driving element, and the second liquid differs from the first liquid.

The present application is based on, and claims priority from JP Application Serial Number 2021-054948, filed Mar. 29, 2021, the disclosure of which is hereby incorporated by reference herein in its entirety.

### BACKGROUND

### 1. Technical Field

The present disclosure relates to a driving waveform determining method, a liquid ejecting apparatus, and a non-transitory computer-readable storage medium storing a computer program.

### 2. Related Art

There is a known method for an ink jet printer of determining parameters defining a waveform of a driving signal based on a result acquired by ejecting ink droplets and measuring ejection characteristics. According to the technique described in JP-A-2010-131910, a plurality of driving signals having respective different parameters that define the driving waveform are prepared. Then, using one of the plurality of driving signals, ink droplets are simultaneously ejected from a plurality of nozzles. The simultaneous ejection of ink droplets using one driving signal is performed with varying number of nozzles. Such processing is performed for each of the driving signals. Then, when ink droplets are simultaneously ejected from the varying number of nozzles, parameters of the driving signal having the smallest deviation in ejecting speed of ink droplets are adopted as parameters of a driving signal actually used in printing. As a result, ink droplets are stably ejected from each nozzle irrespective of the number of nozzles that simultaneously eject the ink droplets in printing.

Inks of different colors may differ in characteristics such as viscosity and surface tension. In using inks having different characteristics such as viscosity and surface tension, the ejection characteristic of the inks ejected from the nozzles, for example, ejection amount, ejection speed, the amount of sub-droplet, or the like, vary even at the application of the same driving signal. For this reason, even if the technique described in JP-A-2010-131910 is used to determine parameters, desirable ejection characteristics for all types of inks used in printers are not always realized.

In addition, in a plurality of ink ejecting devices equipped with driving elements to which the same driving waveform is applicable, when the ink ejecting devices differ from each other in the shape of flow channel or nozzle, ejection characteristics of the ink ejected from the nozzles of the ink ejecting devices, for example, ejection amount, ejection speed, the amount of sub-droplet or the like, vary. Thus, even if the technique described in JP-A-2010-131910 is used to determine parameters, desirable ejection characteristics for all of the ink ejecting devices to which the same driving waveform is applicable are not always realized.

### SUMMARY

An embodiment of the present disclosure provides the method of determining the driving waveform of the driving signal applied to the driving elements of the liquid ejecting device in order to eject a liquid from the liquid ejecting device. This method includes: a first acquiring step of executing first acquisition processing of acquiring first information about an ejection characteristic of a first liquid ejected from the liquid ejecting device when each of a plurality of driving waveform candidates is applied to the driving element; a second acquiring step of executing second acquisition processing of acquiring second information about an ejection characteristic of a second liquid ejected from the liquid ejecting device when each of the plurality of driving waveform candidates is applied to the driving element, the second liquid differing from the first liquid; and a waveform determining step of determining, based on the first information and the second information, the driving waveform.

### BRIEF DESCRIPTION OF THE DRAWINGS

FIG. 1 is a block diagram illustrating the configuration of a printer and a computer in a printing system according to a first embodiment.

FIG. 2 is a perspective view illustrating a part of the configuration of the printer.

FIG. 3 is a sectional view illustrating the cross section of an ink ejecting head, taken along the direction perpendicular to a sub-scanning direction.

FIG. 4 is view illustrating a driving waveform of a driving signal.

FIG. 5 is a flow chart illustrating a method of determining the driving waveform of a driving signal applied to the printer.

FIG. 6 is a flow chart illustrating a method of determining the driving waveform of a driving signal applied to the printer according to a second embodiment.

FIG. 7 is a flow chart illustrating a method of determining the driving waveform of a driving signal applied to the printer according to a third embodiment.

FIG. 8 is a flow chart illustrating a method of determining the driving waveform of a driving signal applied to the printer according to a fourth embodiment.

FIG. 9 is a flow chart illustrating a method of determining the driving waveform of a driving signal according to a fifth embodiment.

FIG. 10 is a block diagram illustrating the configuration of a printer and the computer in a printing system according to a sixth embodiment.

FIG. 11 is a block diagram illustrating printers and the computer that constitute a printing system in a modification example of the sixth embodiment.

FIG. 12 is a block diagram illustrating printers, computers, and a server that constitute a printing system in a modification example of the sixth embodiment.

### DESCRIPTION OF EXEMPLARY EMBODIMENTS

### A. First Embodiment

### A1. Configuration of Printing System

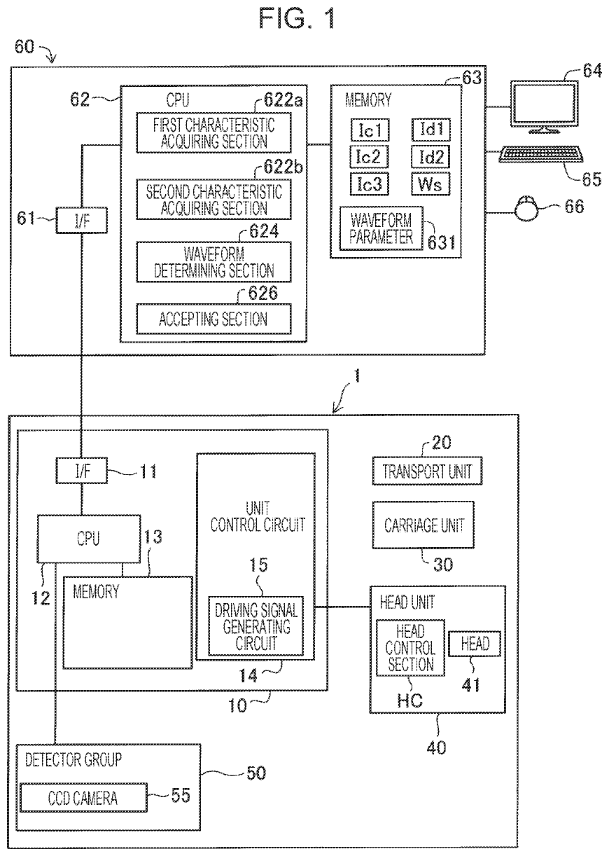

FIG. 1 is a block diagram illustrating the configuration of a printer 1 and a computer 60 in a printing system according to a first embodiment. The printing system includes the printer 1 and the computer 60.

The printer 1 drives driving elements based on printing data, thereby ejecting ink droplets from nozzles to form an image on a printing medium PM. The printer 1 includes a controller 10, a transport unit 20, a carriage unit 30, a head unit 40, and a detector group 50.

The controller 10 is a control unit that controls the printer 1. The controller 10 includes an interface section 11, a CPU 12, a memory 13, and a unit control circuit 14.

The interface section 11 transmits and receives data between the printer 1 and the computer 60. The CPU 12 is an arithmetic processing unit that controls the entire printer 1. The memory 13 includes an auxiliary memory that stores a computer program executed by the CPU 12 and a main memory that serves as a working area. The CPU 12 that is a processor loads the program stored in the auxiliary memory into the main memory and executes the program to perform various functions. The main memory may be a nonvolatile memory, but may be a volatile memory. Both of the nonvolatile memory and the volatile memory may be suitably used as the auxiliary memory.

The unit control circuit 14 controls each of the units of the printer 1 according to an instruction from the CPU 12. The unit control circuit 14 includes a plurality of driving signal generating circuits 15. The driving signal generating circuits 15 generate a driving signal COM including a plurality of driving waveforms W that occur at certain intervals. For facilitating understanding of the technique, in FIG. 1, the driving signal generating circuits 15 are represented as one component.

The transport unit 20 transports the printing medium PM to a printable location by a transport amount of a pattern predetermined at printing. The carriage unit 30 moves an ink ejecting head 41 attached to a carriage 31 in a direction that crosses the transport direction of the printing medium PM. In the present specification, the moving direction of the ink ejecting head 41 is referred to as “main scanning direction Dm”. The transport direction of the printing medium PM is referred to as “sub-scanning direction Ds”.

The head unit 40 ejects ink droplets onto the printing medium PM. The head unit 40 has the ink ejecting head 41 and a head control section HC. A plurality of nozzles Nz are provided on a lower face of the ink ejecting head 41. The ink ejecting head 41 includes a plurality of driving elements PZT. The driving element PZT is specifically, a piezo element. One nozzle Nz is provided with one driving element PZT. The driving elements PZT are driven by the application of the driving signal COM. Due to the driving of the driving elements PZT, the ink ejecting head 41 ejects the ink from the nozzles Nz. The driving element PZT is a piezoelectric element made of lead zirconate titanate in this embodiment and however, may be a piezoelectric element made of any material other than lead zirconate titanate or a heat generating element.

Based on printing data, the head control section HC controls whether or not the driving waveform W of the driving signal COM is applied to the driving element PZT corresponding to each nozzle Nz. When the driving waveform W is applied to the driving element PZT corresponding to one nozzle Nz, the amount of ink corresponding to the driving waveform W is ejected from the nozzle Nz to form a dot on the printing medium PM. On the contrary, when the driving waveform W is not applied to the driving element PZT corresponding to one nozzle Nz, no ink droplet is ejected from the nozzle Nz.

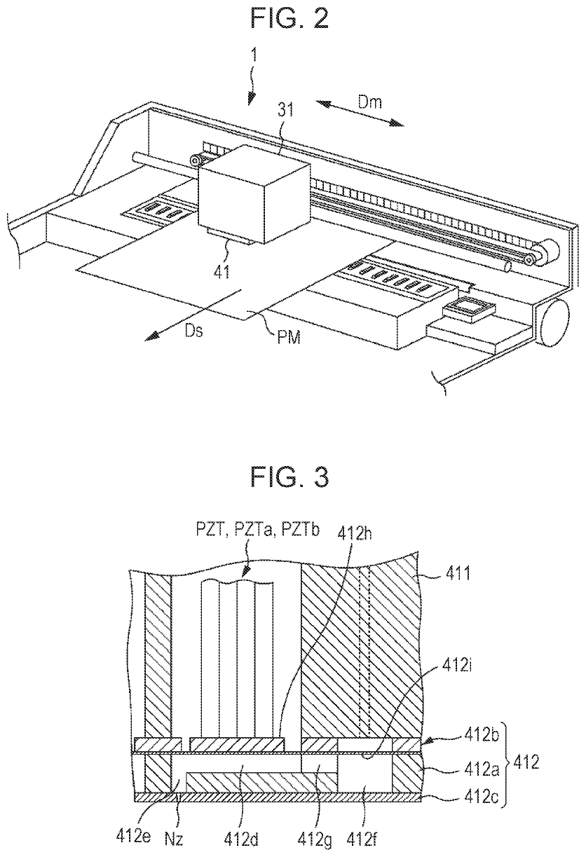

FIG. 2 is a perspective view illustrating a part of the configuration of the printer 1. The printer 1 can perform dot forming processing of causing the ink ejecting head 41 moving in the main scanning direction Dm to intermittently eject ink droplets to form dots on the printing medium PM. The printer 1 can perform transport processing of transporting the printing medium PM in the sub-scanning direction Ds. The printer 1 alternatively repeats the dot forming processing and the transport processing, thereby forming a dot on each location on the printing medium PM to form an image.

The detector group 50 monitors the status of the printer 1 (refer to FIG. 1). According to an output signal from the detector group 50, the controller 10 controls each section constituting the printer 1. The detector group 50 includes a CCD camera 55.

The CCD camera 55 acquires the image of the ink droplets ejected from the ink ejecting head 41 and outputs image data to the CPU 12. The CCD camera 55 can take a static image as well as a moving image. In this specification, the “image” includes the static image and the moving image.

The CCD camera 55 is used to take an image for acquiring information indicative of the ejection characteristic as described below and however, any component capable of acquiring information indicative of the ejection characteristic may be used in place of the CCD camera 55. For example, an electronic scale may be used in place of the CCD camera 55 to acquire information indicative of the ejection characteristic including ejection amount and so on.

The computer 60 transmits the printing data to the printer 1. The computer 60 transmits parameters indicative of driving waveforms of the driving signal of the driving element to the printer 1. The computer 60 includes an interface section 61, a CPU 62, a memory 63, a display 64, a keyboard 65, and a mouse 66.

The display 64 is controlled by the CPU 62 and outputs an image. The keyboard 65 and the mouse 66 are operated by the user and inputs a user's instruction to the CPU 62.

The interface section 61 transmits and receives data between the computer 60 and the printer 1. The memory 63 includes an auxiliary memory that stores a computer program executed by the CPU 62 and a main memory that serves as a working area. The CPU 62 that is a processor loads the program stored in the auxiliary memory into the main memory and executes the program to perform various functions.

For example, the CPU 62 performs the function of acquiring information indicative of the ejection characteristic that is the characteristic of the ink ejected from the ink ejecting head 41. More specifically, the CPU 62 can acquire the ejection speed of the ink ejected from the nozzle Nz and the ejection amount of the ink ejected from one nozzle Nz by the ejecting operation of the driving element PZT, based on the image of ink droplets, which is acquired by the CCD camera 55 of the printer 1. In addition, the CPU 62 performs the function of determining the driving waveform of the driving signal COM applied to the driving element PZT.

FIG. 3 is a sectional view illustrating the cross section of the ink ejecting head 41, taken along the direction perpendicular to the sub-scanning direction Ds. The ink ejecting head 41 has a case 411, a flow channel unit 412, the plurality of driving elements PZT. The case 411 stores the plurality of driving elements PZT. The flow channel unit 412 is bonded to a lower face of the case 411.

The flow channel unit 412 has a flow channel forming plate 412a, an elastic plate 412b, and a nozzle plate 412c.

The flow channel forming plate 412a has a groove that functions as a pressure chamber 412d, a through port that functions as a nozzle communicating port 412e, a through port that functions as a common ink chamber 412f, and a groove that functions as an ink supply channel 412g. One common ink chamber 412f is provided for the plurality of nozzles Nz included in one nozzle row. A set of the ink supply channel 412g, the pressure chamber 412d, and the nozzle communicating port 412e is provided for one nozzle Nz. In the ink ejecting head 41, the ink is supplied to the pressure chamber 412d through the common ink chamber 412f and the ink supply channel 412g. The ink in the pressure chamber 412d is ejected from the nozzle Nz through the nozzle communicating port 412e.

The elastic plate 412b has an island 412h to which a tip of the driving element PZT is bonded. Then, an elastic area formed of an elastic film 412i is formed around the island 412h.

The nozzle plate 412c is a plate on which the plurality of nozzles Nz are formed. A yellow nozzle array for ejecting a yellow ink, a magenta nozzle array for ejecting magenta ink, a cyan nozzle array for ejecting a cyan ink, and a black nozzle array for ejecting a black ink are formed on a nozzle Nz face that is one face of the nozzle plate 412c. Each of the nozzle arrays is constituted of 180 nozzles Nz aligned at predetermined intervals in the sub-scanning direction Ds. The nozzle arrays are aligned in the main scanning direction Dm. FIG. 3 is a sectional view illustrating the cross section perpendicular to the sub-scanning direction Ds. In the unit control circuit 14, one driving signal generating circuit 15 is provided for one nozzle array.

The plurality of driving elements PZT are formed as a plurality of comb-like elements. A circuit board equipped with the head control section HC applies the driving signal COM to the driving elements PZT. The driving elements PZT expands or contracts depending on the potential of the driving signal COM. When the driving elements PZT contract, the island 412h deforms toward the driving elements PZT. When driving elements PZT expand, the island 412h deforms toward the pressure chamber 412d. As a result, the pressure in the pressure chamber 412d changes such that ink droplets are ejected from the nozzles Nz. One driving signal generating circuit 15 is provided for one nozzle array. Thus, the driving signal COM generated by a certain driving signal generating circuit 15 is commonly applied to the driving elements PZT of all nozzles Nz that belong to the nozzle array corresponding to the driving signal generating circuit 15. However, the head control section HC determines whether or not the driving waveform W of the driving signal COM is applied to each of the driving elements PZT.

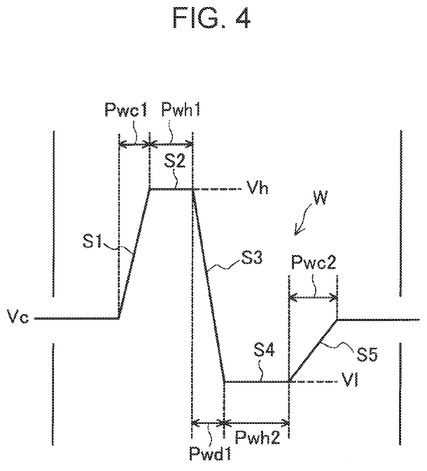

FIG. 4 is a view illustrating the driving waveform W of the driving signal COM. In the driving signal COM, the driving waveform W illustrated in FIG. 4 occurs at a certain cycle. The driving waveform W has a first expansion element S1 that raises the potential from an intermediate potential Vc to a highest potential Vh, a first holding element S2 that holds the highest potential Vh, a contraction element S3 that lowers the potential from the highest potential Vh to a lowest potential Vl, a second holding element S4 that holds the lowest potential Vl, a second expansion element S5 that raises the potential from the lowest potential Vl to the intermediate potential Vc.

In the state where the intermediate potential Vc is applied to the driving elements PZT, no driving element PZT expands or contracts. The volume of the pressure chamber 412d in the state where the intermediate potential Vc is applied to the driving elements PZT is referred to as “reference volume”.

From the state where the intermediate potential Vc is applied to the driving elements PZT, when the first expansion element S1 of the driving signal COM is applied to the driving elements PZT, the driving elements PZT expand or contract in the longitudinal direction. As a result, the volume of the pressure chamber 412d increases (refer to FIG. 3). When the first holding element S2 of the driving signal COM is applied to the driving elements PZT, the contracted state of the driving elements PZT is maintained. At this time, the expanded state of the pressure chamber 412d is also maintained. When the contraction element S3 of the driving signal COM is applied to the driving elements PZT, the driving elements PZT extends from the contracted state. As a result, the volume of the pressure chamber 412d decreases. The pressure of the ink in the pressure chamber 412d increases, causing the nozzles Nz to eject ink droplets. After that, when the second holding element S4 of the driving signal COM is applied to the driving elements PZT, the expanded state of the driving elements PZT and the contracted state of the pressure chamber 412d are maintained. When the second expansion element S5 is applied to the driving elements PZT, the volume of the pressure chamber 412d returns to the reference volume.

The period when the first expansion element S1 occurs is referred to as “first expansion period Pwc1”. The period when first holding element S2 occurs is referred to as “first holding period Pwh1”. The period when contraction element S3 occurs is referred to as “contraction period Pwd1”. The period when second holding element S4 occurs is referred to as “second holding period Pwh2”. The period when second expansion element S5 occurs is referred to as “second expansion period Pwc2”. The first expansion period Pwc1, the first holding period Pwh1, the contraction period Pwd1, the second holding period Pwh2, and the second expansion period Pwc2 are parameters that define the shape of the driving waveform W of the driving signal COM.

### A2. Determination of Driving Waveform

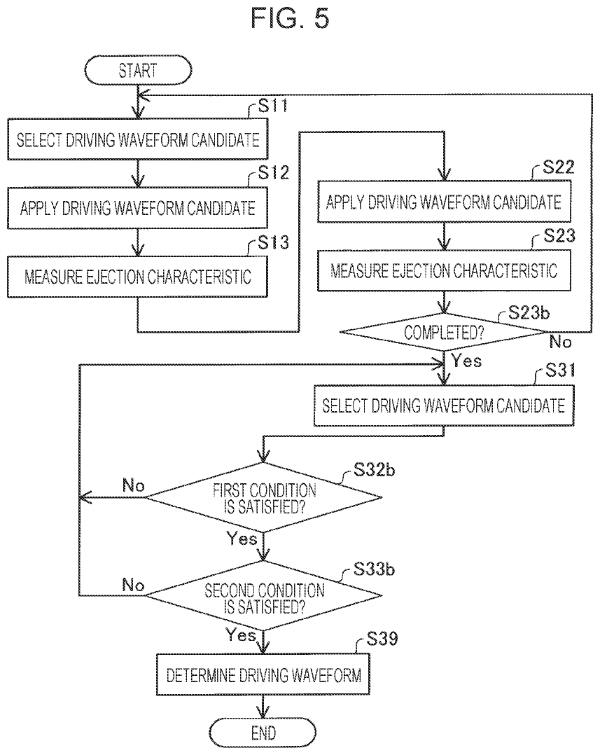

FIG. 5 is a flow chart illustrating a method of determining the driving waveform of the driving signal applied to the printer 1. In response to an instruction from the user, mainly the CPU 62 of the computer 60 controls each section of the computer 60 and the printer 1 to execute processing of the driving waveform determining method in FIG. 5. Through the processing illustrated in FIG. 5, the driving waveform of the driving signal COM applied to the driving elements PZT for causing the ink ejecting head 41 to eject the ink is determined.

In Step S11, the CPU 62 selects one of a plurality of predetermined driving waveform candidates Wci and transmits a set of parameters indicating the selected driving waveform candidate Wci to the printer 1 (refer to FIG. 4). The plurality of predetermined driving waveform candidates Wci are candidates for the driving waveform W of the driving signal COM applied to the printer 1. A plural sets of parameters indicating the driving waveform candidates Wci are previously stored in the memory 63. The plural sets of parameters indicating the plurality of driving waveform candidates Wci are expressed as “waveform parameter 631” in FIG. 1.

In Step S12, the CPU 62 instructs the CPU 12 of the printer 1 to execute following processing. The CPU 12 controls the unit control circuit 14 to generate the driving signal COM based on a set of parameters indicating one of the received driving waveform candidates Wci. Then, the CPU 12 causes the driving signal COM to be applied to the driving elements PZT in the nozzle array that ejects a first ink among the plurality of driving elements PZT of the ink ejecting head 41. As a result, ink droplets of the first ink are ejected from the nozzles Nz. The first ink is, for example, a cyan ink.

In Step S13, the CPU 12 causes the CCD camera 55 to take an image of ink droplets ejected from the nozzles Nz according to the driving signal COM. The CPU 12 transmits image data to the computer 60. In Step S12, the CPU 62 of the computer 60 instructs the CPU 12 of the printer 1 to execute the above processing in Steps S12 and S13.

In Step S13, based on the image data, the CPU 62 calculates an ejection amount Pwa of the first ink ejected from one nozzle Nz of the ink ejecting head 41 by the ejecting operation of the driving element PZT. The ink ejection amount is defined by the mass. Since the mass is based on volume and ink density, the ink ejection amount may be defined by volume. The ink ejection amount is one mode of “ejection characteristic”. The CPU 62 associates information indicating the ejection characteristic of the first ink with information that identifies the first ink, and stores the information in the memory 63. The information indicating the ejection characteristic is referred to as “first information Ic1”. The first information Ic1 refers to the ejection characteristic of the first ink ejected from the head unit 40 when a certain driving waveform candidate Wci is applied to the driving elements PZT. The ejection amount ejected from one nozzle Nz by one ejecting operation of the driving elements PZT may be used as the ejection amount Pwa of the ink.

In this specification, the processing of acquiring the first information Ic1 in Steps S12 and S13 is referred to as “first acquisition processing”.

The processing in Steps S22 and S23 is substantially same as the processing in Steps S12 and S13, respectively. However, the processing in Steps S12 and S13 is executed for the nozzle array that ejects the first ink, while the processing in Steps S22 and S23 is executed for the nozzle array that ejects a second ink that differs from the first ink. Other matters in Steps S22 and S23 are the same as those in Steps S12 and S13.

That is, in Step S22, the CPU 12 causes the generated driving signal COM to be applied to the driving elements PZT of the nozzle array that ejects the second ink, among the plurality of driving elements PZT of the ink ejecting head 41. As a result, ink droplets of the second ink are ejected from the nozzles Nz. The second ink is, for example, the magenta ink.

In Step S23, based on image data, the CPU 62 calculates an ejection amount Pwb of the second ink ejected from one nozzle Nz of the ink ejecting head 41 by the ejecting operation of the driving elements PZT. The CPU 62 associates information indicating the ejection characteristic of the second ink with information that identifies the second ink, and stores the information in the memory 63. The information indicating the ejection characteristic is referred to as “second information Ic2”. The second information Ic2 refers to the ejection characteristic of the second ink ejected from the head unit 40 when a certain driving waveform candidate Wci is applied to the driving elements PZT.

In this specification, the processing of acquiring the second information Ic2 in Steps S22 and S23 is referred to as “second acquisition processing”.

In Step S23b, the CPU 62 determines whether or not the processing in Steps S12 to S23 has been executed for all of the driving waveform candidates Wci to be measured with respect to the ejection characteristic. When the processing in Steps S12 to S23 has been executed for all of the driving waveform candidates Wci to be measured with respect to the ejection characteristic, the processing proceeds to Step S31. When the processing in Steps S12 to S23 has not been executed for all of the driving waveform candidates Wci to be measured with respect to the ejection characteristic, the processing returns to Step S11. Then, one driving waveform candidate Wci for which the processing in Steps S12 to S23 has not been executed is selected from among the plurality of driving waveform candidates Wci, and the processing in Steps S12 to S23 is executed.

By repeating the processing in Steps S12 and S13, for each of the plurality of predetermined driving waveform candidates Wci, the first acquisition processing is executed. As a result, the first information Ic1 about the plurality of predetermined driving waveform candidates Wci is stored in the memory 63 (refer to FIG. 1).

By repeating the processing in Steps S22 and S23, the second acquisition processing is executed for each of the plurality of predetermined driving waveform candidates Wci. As a result, the second information Ic2 about the plurality of predetermined driving waveform candidates Wci is stored in the memory 63 (refer to FIG. 1).

A functional section of the CPU 62, which executes the processing in Steps S12 and S13, is illustrated as a first characteristic acquiring section 622a in FIG. 1. A functional section of the CPU 62, which executes the processing in Steps S22 and S23, is illustrated as a second characteristic acquiring section 622b in FIG. 1.

In Step S31 in FIG. 5, the CPU 62 selects one of the plurality of predetermined driving waveform candidates Wci.

In Step S32b, the CPU 62 determines whether or not the ejection characteristic indicated by the first information Ic1 about the selected driving waveform candidate Wci satisfies a predetermined first condition. Specifically, the CPU 62 executes following processing.

First, the CPU 62 acquires a first deviation information Id1 indicating a difference between the ejection characteristic indicated as the first information Ic1 and a target ejection characteristic that is an ideal ejection characteristic. As a specific example, a value Dwa is calculated as the first deviation information Id1 according to a below formula.

Dwa=|Pwt−Pwa| . . . (1)

Pwt is an ideal ejection amount.

Pwa is the ejection amount indicated by the first information Ic1, which is the ejection amount of the first ink when a certain driving waveform candidate Wci is applied to the printer 1.

The CPU 62 determines whether or not the selected driving waveform candidates Wci satisfies Dwa≤Thwa. Thwa is a predetermined threshold that is a positive number less than Pwt. That is, in this embodiment, the first condition is Dwa≤Thwa.

The first condition may be also expressed as follows:

[Pwt−Thwa]≤Pwa≤[Pwt+Thwa] . . . (2)

That is, the first condition is that the value expressed by the ejection characteristic of the first ink falls within a predetermined first range [Pwt−Thwa] to [Pwt+Thwa].

By determining the first condition in this manner, Thwa that defines the first range in the above formula (2) can be appropriately set to determine the driving waveform W achieving the desirable ejection characteristic for a first liquid.

In Step S32b, when the ejection characteristic satisfies the first condition, the processing proceeds to Step S33b. When the ejection characteristic does not satisfy the first condition, the processing returns to Step S31.

In Step S33b, the CPU 62 determines whether or not the ejection characteristic indicated by the second information Ic2 about the selected driving waveform candidate Wci satisfies a predetermined second condition. Specifically, the CPU 62 executes following processing.

First, the CPU 62 acquires a second deviation information Id2 indicating a difference between the ejection characteristic indicated by the second information Ic2 and the target ejection characteristic that is the ideal ejection characteristic. As a specific example, a value Dwb is calculated as the second deviation information Id2 according to a following formula.

Dwb=|Pwt—Pwb| . . . (3)

Pwb is the ejection amount indicated by the second information Ic2, which is the ejection amount of the second ink when a certain driving waveform candidate Wci is applied to the printer 1.

The CPU 12 determines whether or not the selected driving waveform candidate Wci satisfies Dwb≤Thwb. Thwb is a predetermined threshold that is a positive number less than Pwt. That is, in this embodiment, the second condition is Dwb≤Thwb.

The second condition may be also expressed as follows:

[Pwt−Thwb]≤Pwb≤[Pwt+Thwb] . . . (4)

That is, the second condition is that the value expressed by the ejection characteristic of the second ink falls within a predetermined second range [Pwt−Thwb] to [Pwt+Thwb].

By determining the second condition in this manner, Thwb that defines the second range in the above formula (4) can be appropriately set to determine the driving waveform W achieving the desirable ejection characteristic for a second liquid.

In Step S33b, when the ejection characteristic satisfies the second condition, the processing proceeds to Step S39. When the ejection characteristic does not satisfy the first condition, the processing returns to Step S31.

When the processing returns to Step S31 from Step S32b or Step S33b, in Step S31, one driving waveform candidate Wci for which the processing in Step S32b has not executed is selected from among the plurality of driving waveform candidates Wci. Then, processing in Step S32b and subsequent steps is executed.

In Step S39, the CPU 62 determines the driving waveform candidate Wci selected in Step S31 last performed as the driving waveform W of the driving signal COM applied to the driving elements PZT of the ink ejecting head 41.

As a result, in Step S39, the driving waveform W is determined based on the first information Tel, the second information Ic2, and at least a part of the plurality of predetermined driving waveform candidates Wci. A functional section of the CPU 62, which executes the processing in Steps S31 to S39 is illustrated in a waveform determining section 624 in FIG. 1.

By executing the processing in Steps S32b and S33b prior to Step S39, in Step S39, among the plurality of predetermined driving waveform candidates Wci, the driving waveform candidate Wci with which the ejection characteristic indicated by the first information Tel satisfies the predetermined first condition and the ejection characteristic indicated by the second information Ic2 satisfies the predetermined second condition is determined as the driving waveform W.

With such aspect, driving waveforms W achieving the desirable ejection characteristic for both the first ink and the second ink can be determined. More specifically, the driving waveform W having a small difference in the ejection amount between different types of inks ejected from the nozzles Nz can be determined.

The printing system according to this embodiment is also referred to as “liquid ejecting apparatus” (refer to FIG. 1). The head unit 40 is also referred to as “liquid ejecting device”. The unit control circuit 14 is also referred to as “driving control section”. Repeatedly performed Step S13 in FIG. 5 is also referred to as “first acquiring step”. Repeatedly performed Step S23 is also referred to as “second acquiring step”. Steps S31 to S39 are also referred to as “waveform determining step”.

### B. Second Embodiment

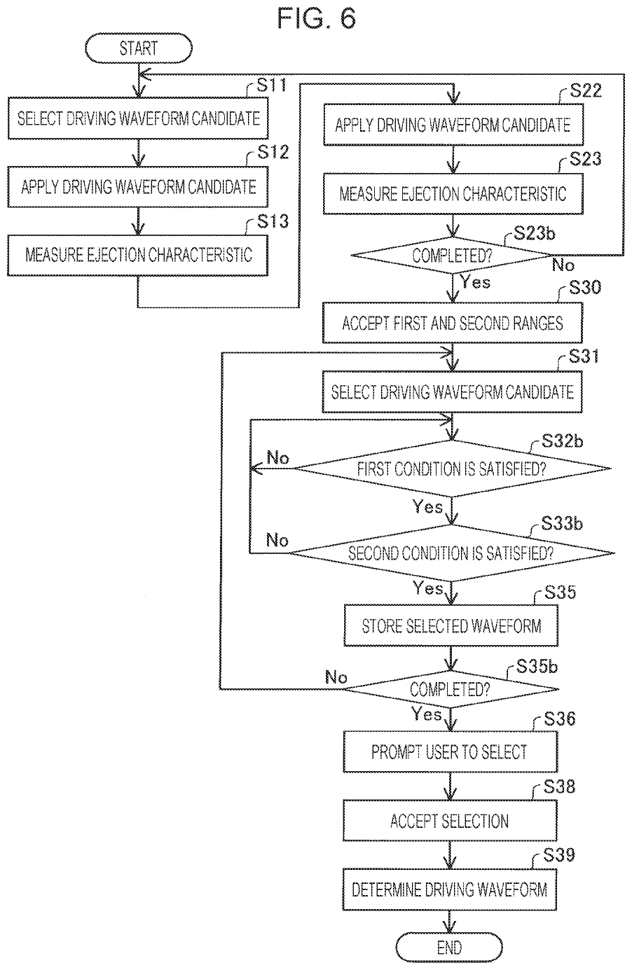

FIG. 6 is a flow chart illustrating a method of determining the driving waveform of a driving signal applied to the printer 1 according to a second embodiment. In the second embodiment, steps performed after Step S23b in the method in FIG. 6 differ from the steps in the method according to the first embodiment illustrated in FIG. 5. Other matters in the second embodiment are the same as those in the first embodiment. In the method illustrated in FIG. 6, after Step S23b, processing in Step S30 is executed.

In Step S30, the CPU 62 accepts inputs of the first range and the second range. In the first embodiment, the first range and the second range are predetermined (refer to the above formulas (2) and (4)). However, in the second embodiment, the first range and the second range are defined in response to an input from the user.

Specifically, the CPU 62 causes the display 64 to display a prompt for an input of the first range about the ejection characteristic of the first ink. Then, the CPU 62 accepts an input of the first range from the user via the keyboard 65 and the mouse 66. In addition, the CPU 62 causes the display 64 to display a prompt for an input of the second range about the ejection characteristic of the second ink. Then, the CPU 62 accepts an input of the second range from the user via the keyboard 65 and the mouse 66. In this embodiment, the first range and the second range are allowable ranges of the ejection amount of ink ejected from one nozzle Nz by the ejecting operation of the driving elements PZT. A functional section of the CPU 62, which performs the function in Step S30, is the “waveform determining section 624” (refer to FIG. 1).

By executing the processing in Step S30, the user can appropriately define the first condition and the second condition to determine the driving waveform W achieving the desirable ejection characteristic for each of the first ink and the second ink.

The processing in Steps S31 to S33b in FIG. 6 is substantially same as the processing in Steps S31 to S33b in FIG. 5 according to the first embodiment.

In Step S35, the CPU 62 adds the driving waveform candidate Wci selected in Step S31 last performed is added to a selected waveform Ws stored in the memory 63 (refer to FIG. 1). When the processing in Step S35 is first executed in the processing in FIG. 6, the CPU 62 stores the driving waveform candidate Wci selected in Step S31 last performed as the selected waveform Ws.

In Step S35b, the CPU 62 determines whether or not the processing in Step S32b has been executed for all of the driving waveform candidates Wci. When the processing in Step S32b has been executed for all of the driving waveform candidates Wci to be measured with respect to the ejection characteristic, the processing proceeds to Step S36. When the processing in Step S32b has not been executed for all of the driving waveform candidates Wci to be measured with respect to the ejection characteristic, the processing returns to Step S31. Then, in Step S31, one driving waveform candidate Wci for which the processing in Step S32b has not been executed is selected from among the plurality of driving waveform candidates Wci, and the processing in Step S32b is executed.

By repeating the processing in Steps S31 to S35, among the plurality of predetermined driving waveform candidates Wci, one or more driving waveform candidates Wci with which the ejection characteristic indicated by the first information Ic1 satisfies the first condition and the ejection characteristic indicated by the second information Ic2 satisfies the predetermined second condition are stored as the selected waveforms Ws in the memory 63 (refer to FIG. 1).

In Step S36, the CPU 62 causes the display 64 to display the driving waveform candidates Wci included in the selected waveforms Ws, and the ejection characteristic indicated by the first information Ic1 and the ejection characteristic indicated by the second information Ic2 of the driving waveform candidates. Simultaneously, the CPU 62 causes the display to display a prompt to input of selection of the driving waveform candidate Wci from the driving waveform candidates Wci included in the selected waveforms Ws.

In Step S38, the CPU 62 accepts an input of the selection of the driving waveform candidate Wci from the user viewing the display in Step S36 using the keyboard 65 and the mouse 66. As a result, an input of the selection from one or more driving waveform candidates Wci with which the ejection characteristic indicated by the first information Ic1 satisfies the first condition and the ejection characteristic indicated by the second information Ic2 satisfies the predetermined second condition from among the plurality of predetermined driving waveform candidates Wci is accepted. A functional section of the CPU 62, which performs the functions in Steps S36 and S38, is the waveform determining section 624. The processing in Step S36, Step S36b, Step S38 may be automatically executed according to a predetermined algorithm.

In Step S39, the CPU 62 determines the driving waveform candidate Wci selected in Step S36 as the driving waveform W of the driving signal COM applied to the driving elements PZT of the ink ejecting head 41.

By executing such processing, the user's intention about the ejection characteristic of the first ink and the ejection characteristic of the second ink can be reflected to determine the driving waveform W (refer to Steps S30 and S38 in FIG. 6).

### C. Third Embodiment

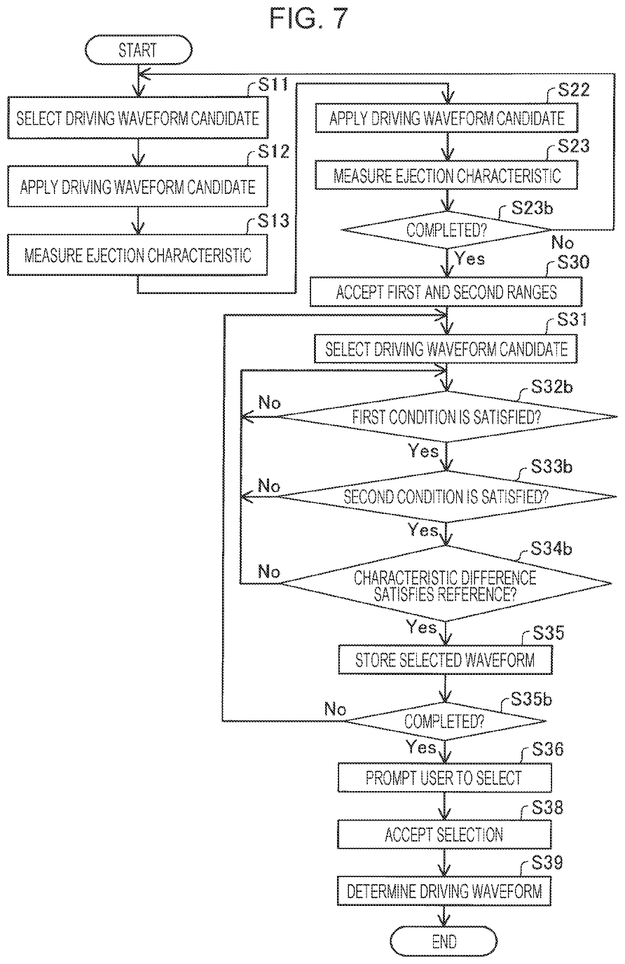

FIG. 7 is a flow chart illustrating a method of determining the driving waveform of a driving signal applied to the printer 1 according to a third embodiment. In the third embodiment, processing in Step S34b is executed between Step S33b and Step S35 in the method according to the second embodiment in FIG. 6. Other matters in the third embodiment are the same as those in the second embodiment.

In Step S34b, for the driving waveform candidate Wci, the CPU 62 determines whether or not a difference between the ejection characteristic indicated by the first information Ic1 and the ejection characteristic indicated by the second information Ic2 is smaller than a predetermined reference. Specifically, the CPU 62 executes following processing.

The CPU 62 calculates a following estimated value DPw for the selected driving waveform candidate Wci as third information Ic3. A formula (5) is a specific example.

DPw=|Pwb−Pwa| . . . (5)

The CPU 12 determines whether or not the selected driving waveform candidate Wci satisfies DPw≤Thwp. Thwp is a predetermined threshold that is a positive number less than Pwb and Pwa. In this embodiment, the ejection amount Pwa of the first ink ejected from one nozzle Nz of the ink ejecting head 41 by the ejecting operation of the driving elements PZT is the ejection characteristic indicated by the first information Ic1. The ejection amount Pwb of the second ink ejected from one nozzle Nz of the ink ejecting head 41 by the ejecting operation of the driving elements PZT is the ejection characteristic indicated by the second information Ic2. The predetermined reference is a threshold Thwp.

In Step S34b, the difference between the ejection characteristic indicated by the first information Ic1 and the ejection characteristic indicated by the second information Ic2 is smaller than the predetermined reference, the processing proceeds to Step S35. When the difference between the ejection characteristic indicated by the first information Ic1 and the ejection characteristic indicated by the second information Ic2 is not smaller than the predetermined reference, the processing returns to Step S32b.

The processing in Step S35 and subsequent steps is the same as the processing in Step S35 and subsequent steps in FIG. 6.

By executing the processing in Step S34b, among the plurality of predetermined driving waveform candidates Wci, the driving waveform candidate Wci having a smaller difference between the ejection characteristic indicated by the first information Ic1 and the ejection characteristic indicated by the second information Ic2 than the predetermined reference is determined as the driving waveform W. As a result, the driving waveform that brings the ejection characteristic of the first ink closer to the ejection characteristic of the second ink can be preferentially selected. For example, when the first ink and the second ink, for example, the cyan ink and the magenta ink, are equally used in generating a print, the quality of the generated product can be improved.

### D. Fourth Embodiment

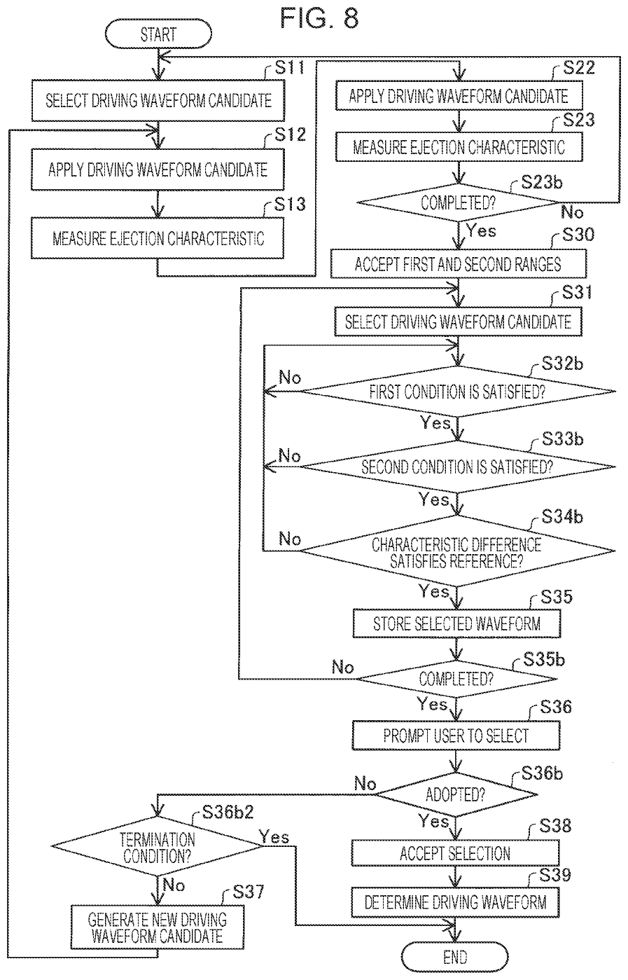

FIG. 8 is a flow chart illustrating a method of determining the driving waveform of a driving signal applied to the printer 1 according to a fourth embodiment. In the fourth embodiment, processing in Steps S36b, S36b2, and S37 is executed between Step S36 and Step S38 in the method according to the third embodiment in FIG. 7. In the fourth embodiment, in the processing in Steps S13 and S23 in FIG. 8, further processing is executed in addition to the processing in Steps S13 and S23 in FIG. 5. Other matters in the fourth embodiment are the same as those in the third embodiment.

In Step S13 in FIG. 8, based on image data, the CPU 62 calculates the ejection amount Pwa of the first ink. Further, based on the image data, the CPU 62 calculates a total amount Psa of sub-droplets of the first ink ejected from one nozzle Nz of the ink ejecting head 41 by the ejecting operation of the driving elements PZT. The total amount of sub-droplets is defined by the number of sub-droplets. The total amount of sub-droplets is one mode of “ejection characteristic”. The CPU 62 stores the total amount Psa of sub-droplets along with the ejection amount Pwa of the ink as the first information Ic1 in the memory 63 (refer to FIG. 1).

In Step S23 in FIG. 8, based on image data, the CPU 62 calculates the ejection amount Pwa of the second ink. Further, based on the image data, the CPU 62 calculates a total amount Psb of sub-droplets of the second ink ejected from one nozzle Nz of the ink ejecting head 41 by the ejecting operation of the driving elements PZT. The CPU 62 stores the total amount Psb of sub-droplets along with the ejection amount Pwb of the ink as the second information Ic2 in the memory 63 (refer to FIG. 1).

In Step S36b, the CPU 62 of the computer 60 determines whether or not the driving waveform candidate Wci included in the selected waveform Ws satisfies a predetermined condition. The predetermined condition is a condition to be satisfied by the driving waveform applied to the printer 1. When the driving waveform candidates Wci does not satisfy this condition, the driving waveform candidate Wci cannot be adopted as the driving waveform applied to the printer 1. Here, the condition that both of the total amounts Psa and Psb of sub-droplets are a predetermined threshold Ths or less is adopted as the predetermined condition. However, any other condition may be adopted as the predetermined condition.

When there is the driving waveform candidate Wci with which both of the total amounts Psa and Psb of sub-droplets are the predetermined threshold Ths or less, the processing proceeds to Step S38. When there is no driving waveform candidate Wci with which both of the total amounts Psa and Psb of sub-droplets is the predetermined threshold Ths or less, the processing proceeds to Step S36b2. That is, the case where the processing in Step S36b2 and subsequent Step S37 is executed is the case where no driving waveform W is selected from among the plurality of predetermined driving waveform candidates Wci.

In Step S36b2, the CPU 62 determines a termination condition. Specifically, the CPU 62 determines whether or not the number of times the procedure reaches Step S36b2 through Step S36b exceeds a predetermined threshold. When the number of times the procedure reaches Step S36b2 through Step S36b exceeds a predetermined threshold, the processing is terminated. When the number of times the procedure reaches Step S36b2 through Step S36b does not exceed a predetermined threshold, the processing proceeds to Step S37.

In Step S37, the CPU 62 generates new driving waveform candidates based on the first information Ic1, the second information Ic2, and a part of the plurality of predetermined driving waveform candidates Wci. Specifically, using an optimizing method, the CPU 62 determines a set of parameters that defines one or more new driving waveform candidates Wci based on parameters that define the driving waveform candidates Wci included in the selected waveform Ws, and the estimated values DPw of the driving waveform candidates Wci. The estimated value DPw is information defined based on the first information Ic1 and the second information Ic2 (refer to the above formula (5)). Various optimizing methods such as Bayze optimization may be adopted.

After that, using the set of parameters that defines the new driving waveform candidates Wci, the processing in Step S12 and subsequent steps is executed. Then, the driving waveform W is determined based on the first information Ic1 and the second information Ic2 about the new driving waveform candidates Wci, and the new driving waveform candidates Wci.

With such aspect, better driving waveform W can be determined without being limited to the plurality of predetermined driving waveform candidates Wci. Also from the aspect of the fourth embodiment, in Step S37, since the new driving waveform candidates Wci are generated based on the plurality of predetermined driving waveform candidates Wci, the driving waveform W is determined based on the plurality of predetermined driving waveform candidates Wci.

### E. Fifth Embodiment

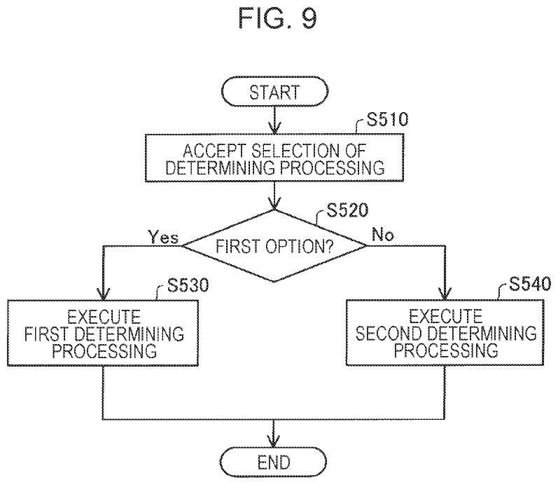

FIG. 9 is a flow chart illustrating a method of determining the driving waveform of a driving signal according to a fifth embodiment. The method of determining the driving waveform of the driving signal according to the fifth embodiment includes the method of determining the driving waveform of the driving signal according to the first embodiment, in a part of the processing. The hardware configuration of the printing system according to the first embodiment is the same as the hardware configuration according to the first embodiment.

In Step S510, the CPU 62 of the computer 60 causes the display 64 to display a prompt to select the method of determining the driving waveform of the driving signal. Specifically, it is prompted to determine the driving waveform that brings similar ejection results for different inks or the optimum driving waveform for a particular ink. Hereinafter, processing of determining the driving waveform that brings similar ejection results for different inks is referred to as “first option”. Processing of determining an optimum driving waveform for a particular ink is referred to as “second option”.

Then, the CPU 62 accepts the selection of the first option or the second option using the keyboard 65 and the mouse 66. A functional section of the CPU 62, which performs the function in Step S510, is illustrated as “accepting section 626” in FIG. 1.

In Step S520, the CPU 62 of the computer 60 determines whether or not the first option is selected. When the first option is selected, the processing proceeds to Step S530. When the first option is not selected and the second option is selected, the processing proceeds to Step S540.

In Step S530, the CPU 62 of the computer 60 executes the processing in first embodiment in FIG. 5 to determine the driving waveform W. In Step S530, the driving waveform W is determined based on the first information Ic1, the second information Ic2, and at least a part of the plurality of driving waveform candidates Wci. This processing is referred to as “first determining processing”. The “first option” is the option of selecting the “first determining processing”.

In Step S540, the CPU 62 of the computer 60 executes the processing in Steps S11, S22 to S23b, S31, S33b, and S39 in the processing according to the first embodiment in FIG. 5 to determine the driving waveform W. As a result, the driving waveform W is determined based on the second information Ic2 about the second ink and the plurality of predetermined driving waveform candidates Wci, not based on the first information Ic1 about the first ink. This processing is referred to as “second determining processing”. The “second option” is the option of selecting the “second determining processing”.

That is, the CPU 62 executes the determining processing selected in Step S520, that is, the first determining processing or the second determining processing, in Step S530 or Step S540.

In this embodiment, when it is preferred to determine the driving waveform W optimized for the second ink, the user can select the second determining processing to cause the driving waveform determining apparatus to execute the second determining processing. As a result, the driving waveform W optimized for the second ink is determined.

### F. Sixth Embodiment

A printer 1a according to a sixth embodiment includes, as head units, a first head unit 40a and a second head unit 40b that differ from each other in configuration. Then, in the sixth embodiment, processing in Steps S12, S13, S22, and S23 in FIG. 5 differs from the processing according to the first embodiment. Other matters in the fourth embodiment are the same as those in the first embodiment.

### F1. Configuration of Printing System

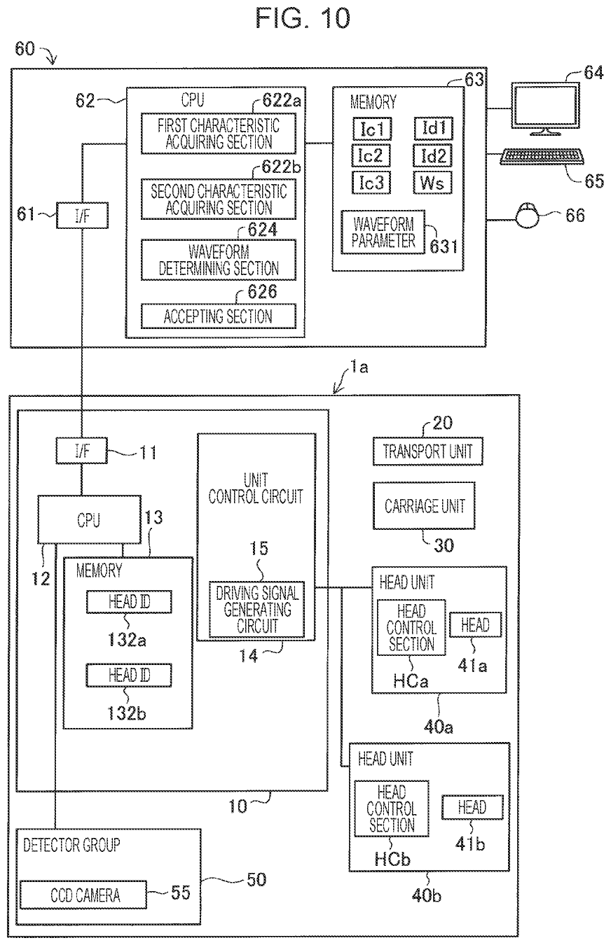

FIG. 10 is a block diagram illustrating the configuration of a printer 1a and the computer 60 in a printing system according to the sixth embodiment. The first head unit 40a includes an ink ejecting head 41a including driving elements PZTa and a head control section HCa. The second head unit 40b includes an ink ejecting head 41b including driving elements PZTb and a head control section HCb. The configuration of the first head unit 40a and the second head unit 40b is the substantially same as the configuration of the head unit 40 according to the first embodiment.

The configuration of the second head unit 40b partially differs from the configuration of the first head unit 40a. Specifically, the shape of an ink flow channel from outside to the ink ejecting head 41a in the first head unit 40a differs from the shape of an ink flow channel from outside to the ink ejecting head 41b in the second head unit 40b. The first head unit 40a and the second head unit 40b have the same configuration except for the above.

The ink ejected from the nozzles Nz of the ink ejecting head 41b is the same as the ink ejected from the nozzles Nz of the ink ejecting head 41a.

In response to an instruction from the CPU 12, the unit control circuit 14 controls each unit of the printer 1a including the first head unit 40a and the second head unit 40b. The driving signal generating circuit 15 supplies the driving signal COM to the first head unit 40a and the second head unit 40b.

### F2. Determination of Driving Waveform

In the sixth embodiment, according to the method in FIG. 5, the driving waveform W common to the driving signal COM applied to the driving elements PZTa of the first head unit 40a and the driving signal COM applied to the driving elements PZTb of the second head unit 40b is determined. However, the processing in Steps S12, S13, S22, and S23 in FIG. 5 differs from the processing according to the first embodiment.

In Step S12 in FIG. 5, the CPU 12 controls the unit control circuit 14 to generate the driving signal COM based on a set of parameters indicating one received driving waveform candidate Wci. Then, the CPU 12 causes the driving signal COM to be applied to the driving elements PZTa of the ink ejecting head 41a. As a result, ink droplets are ejected from the nozzles Nz of the ink ejecting head 41a. Other matters of Step S12 in the sixth embodiment are the same as those in the processing in Step S12 in the first embodiment.

In Step S13, the CPU 62 associates the first information Ic1 indicative of the ejection characteristic of the ink with information that identifies the first head unit 40a, and stores the information in the memory 63. The information that identifies the first head unit 40a is previously stored in the memory 13 of the printer 1a. In FIG. 10, information that identifies the first head unit 40a is illustrated as “head ID 132a”. The CPU 62 of the computer 60 receives the information that identifies the first head unit 40a from the printer 1a.

The processing in Steps S22 and S23 is the substantially same as the processing in Steps S12 and S13 according to the sixth embodiment, respectively. However, the processing in Steps S12 and S13 in the sixth embodiment is executed for the first head unit 40a, while the processing in Steps S22 and S23 in the sixth embodiment is executed for the second head unit 40b. Other matters in Steps S22 and S23 in the sixth embodiment are the same as those in Steps S12 and S13.

That is, in Step S22, the CPU 12 causes the generated driving signal COM to be applied to the driving elements PZTb of the ink ejecting head 41b. As a result, ink droplets are ejected from the nozzles Nz of the ink ejecting head 41b. The ink ejected from the nozzles Nz of the ink ejecting head 41b is the same as the ink ejected from the nozzles Nz of the ink ejecting head 41a. Other matters of Step S22 in the sixth embodiment are the same as those in the processing in Step S12 in the sixth embodiment.

In Step S23, the CPU 62 associates the second information Ic2 indicative of the ejection characteristic of ink with information that identifies the second head unit 40b, and stores the information in the memory 63. The information that identifies the second head unit 40b is previously stored in the memory 13 of the printer 1a. In FIG. 10, the information that identifies the second head unit 40b is referred to as “head ID 132b”. The CPU 62 of the computer 60 receives the information that identifies the second head unit 40b from the printer 1a.

In the sixth embodiment, the functional sections of the CPU 62, which execute the processing in Steps S12, S13, S22, and S23, are the first characteristic acquiring section 622a and the second characteristic acquiring section 622b (refer to FIG. 10).

The other matters of the method of determining the driving waveform of the driving signal applied to the printer 1a according to the sixth embodiment are the same as those of the method of determining the driving waveform of the driving signal applied to the printer 1a according to the first embodiment. In Step S39, the driving waveform W common to the driving signal COM applied to the driving elements PZTa of the first head unit 40a and the driving signal COM applied to the driving elements PZTb of the second head unit 40b is determined. This processing is executed by the waveform determining section 624 that is the functional section of the CPU 62 (refer to FIG. 10).

According to the sixth embodiment, the driving waveform W achieving the desirable ejection characteristic, more specifically, the desirable ejection amount for both the first head unit 40a and the second head unit 40b can be determined. As a result, for example, even when a head unit having a large manufacturing error is used, the quality of a print can be improved by determining the driving waveform as described above.

The printing system according to this embodiment is also referred to as “liquid ejecting apparatus” (refer to FIG. 10). The first head unit 40a is also referred to as “first liquid ejecting device”. The second head unit 40b is also referred to as “second liquid ejecting device”. The driving elements PZTa is also referred to as “first driving element”. The driving elements PZTb is also referred to as “second driving element”. The unit control circuit 14 is also referred to as “driving control section”. Repeatedly performed Step S13 in FIG. 5 is also referred to as “first acquiring step”. Repeatedly performed Step S23 is also referred to as “second acquiring step”. Step S31 to S39 are also referred to as “waveform determining step”.

### F3. Modification Example of Sixth Embodiment

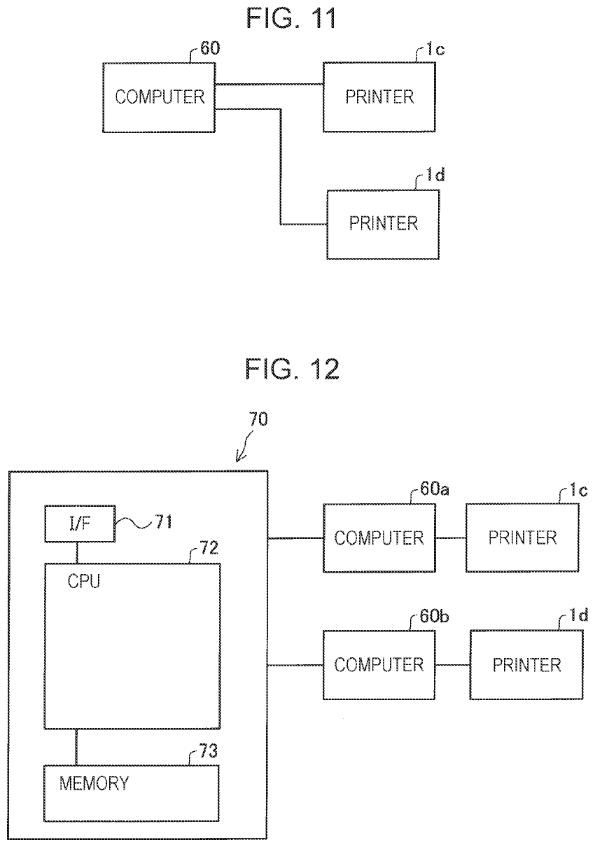

(1) FIG. 11 is a block diagram illustrating printers 1c and 1d and the computer 60 that constitute a printing system in a modification example of the sixth embodiment. In the printing system according to the sixth embodiment, the two printers 1c and 1d are coupled to the computer 60.

The configuration of the computer 60 is the same as the configuration of the computer 60 according to the first embodiment described with reference to FIG. 1. The computer 60 can transmit different printing data to the printers 1c and 1d. The computer 60 can transmit the same printing data to the printer 1c and 1d. The computer 60 transmits the parameters indicative of the driving waveform of the driving signal to the printers 1c and 1d. In this embodiment, the computer 60 transmits the same parameter indicative of the driving waveform of the driving signal to the printer 1c and 1d. That is, the printer 1c and 1d are driven by the driving signal COM having the same driving waveform W.

The configuration of the printers 1c and 1d is the substantially same as the configuration of the printer 1 according to the first embodiment. The printer 1c includes the first head unit 40a. The configuration of the first head unit 40a of the printer 1c in this modification example is the same as the configuration of the first head unit 40a in the sixth embodiment. The printer 1d includes the second head unit 40b. The configuration of the second head unit 40b of the printer 1d in this modification example is the same as the configuration of the second head unit 40b in the sixth embodiment. The other matters of the configuration of the printers 1c and 1d are the substantially same as those of the configuration of the printer 1 according to the first embodiment. That is, the shape of the ink flow channel from outside to the ink ejecting head 41a in the first head unit 40a in the printer 1c differs from the shape of the ink flow channel from outside to the ink ejecting head 41b in the second head unit 40b in the printer 1d.

The method of determining the driving waveform of the driving signal applied to the first head unit 40a and the second head unit 40b of the printer 1a according to the sixth embodiment can be also applied to the printer 1c having the first head unit 40a and the printer 1d having the second head unit 40b. With such aspect, for example, when printers 1c and 1d of different models using the ink ejecting head 41 of the same model, or printers 1c and 1d made by different manufactures using the ink ejecting head 41 of the dame model are used, the quality of a print can be improved.

(2) FIG. 12 is a block diagram illustrating printers 1c and 1d, computers 60a and 60b, and a server 70 that constitute a printing system in a modification example of the sixth embodiment. In this modification example, the printing system includes a combination of the computer 60a and the printer 1c, a combination of the computer 60b and the printer 1d, and the server 70.

The configuration of the computers 60a and 60b is the same as the configuration of the computer 60 according to the first embodiment described with reference to FIG. 1. The configuration of the printers 1c and 1d is the same as the configuration of the printers 1c and 1d in the modification example of the sixth embodiment, which is described with reference to FIG. 11.

The server 70 includes an interface section 71, a CPU 72, and a memory 73. The interface section 71 performs transmission/reception of data between the server 70 and the computers 60a and 60b. The memory 73 includes an auxiliary memory that stores a computer program performed by the CPU 72 and a main memory that functions as a working area. The CPU 72 that is a processor loads the program stored in the auxiliary memory into the main memory and performs the program, thereby performing various functions.

The method of determining the driving waveform of the driving signal applied to the printer 1a according to the sixth embodiment can be also applied to the printer 1c having the first head unit 40a in FIG. 12 and the printer 1d having the second head unit 40b. The functions of the CPU 62 described in the sixth embodiment may be performed by the CPU of the computer 60a, or the CPU of the computer 60b, or the CPU 72 of the server 70.

### G. Further Embodiments

### G1. Further Embodiment 1

(1) In the first embodiment, the first ink is the cyan ink and the second ink is the magenta ink. However, the first ink and the second ink may have any other color such as yellow, black, red, green, and clear. For example, the second determining processing according to the fifth embodiment may be executed for the black ink (refer to S540 in FIG. 9).

(2) According to the above embodiment, the ideal ejection amount Pwt is common to the first ink and the second ink. However, the ideal ejection amount of the first ink may differ from the ideal ejection amount of the second ink. That is, the ideal ejection characteristic of the first liquid may differ from the ideal ejection characteristic of the second liquid.

(3) In the first embodiment, in the processing in Steps S12, S13, S22, and S23 in FIG. 5, ink droplets are ejected and the ejection characteristic is measured. However, for example, when the first information Ic1 or the second information Ic2 is stored in a memory such as the memory 63 of the computer 60 or the memory 73 of the server 70, such information may be acquired to determine, based on the first information Ic1 and the second information Ic2, the driving waveform.

(4) In the first embodiment, first condition is expressed by the formula (2) and the second condition is expressed by the formula (4). Thwb in the formula (4) may be the same as or different from Thwa in the formula (2).

(5) According to the above embodiment, the liquid ejecting apparatus is the printer that ejects the ink. However, the liquid ejecting apparatus may be any other apparatus such as an apparatus for manufacturing an electronic device.

(6) According to the above embodiment, the first information Ic1 and the second information Ic2 are information indicating the ejection characteristic. However, the first information and the second information may not information indicating the ejection characteristic. That is, the first information and the second information only need to be information related to the ejection characteristic.

(7) According to the above embodiment, in Step S33, the driving waveform W is determined based on the first information Ic1, the second information Ic2, and at least a part of the plurality of predetermined driving waveform candidates Wci. However, the driving waveform may be determined based on the first information and the second information rather than on a plurality of driving waveform candidates.

### G2. Further Embodiment 2

In the first embodiment, in Step S32b in FIG. 5, it is determined whether or not the ejection characteristic indicated by the first information Ic1 about the selected driving waveform candidate Wci satisfies the predetermined first condition. In Step S33b, it is determined whether or not the ejection characteristic indicated by the second information Ic2 about the selected driving waveform candidate Wci satisfies the predetermined second condition. However, to determine the driving waveform, it may be determined whether or not one parameter defined based on the first information Ic1 and the second information Ic2 satisfies a condition.

### G3. Further Embodiment 3

(1) In the first embodiment, the first condition means that the value expressed by the ejection characteristic of the first ink falls within the predetermined first range [Pwt−Thwa] to [Pwt+Thwa]. The second condition means that the value expressed by the ejection characteristic of the second ink falls within the predetermined second range [Pwt−Thwb] to [Pwt+Thwb]. However, the first condition and the second condition may define only an upper limit or lower limit of parameters indicative of the ejection characteristic.

(2) In the first embodiment, first condition is expressed by the formula (2) and the second condition is expressed by the formula (4). The formula (2) and the formula (4) have the same form. However, the first condition and the second condition may be expressed by formulas including different terms. That is, the first condition and the second condition may be any condition as long as they are predetermined.

### G4. Further Embodiment 4

In the second embodiment, in Step S30 in FIG. 6, inputs of the first range and the second range are accepted. However, as in the first embodiment, the first range and the second range may be predetermined. Alternatively, after acquisition of the first information Ic1 and the second information Ic2 that indicate the ejection characteristic, the first range and the second range may be defined based on the first information Ic1 and the second information Ic2.

### G5. Further Embodiment 5

In the second embodiment, in Step S38 in FIG. 6, an input of the selection of the driving waveform candidate Wci is accepted from the selected waveforms Ws. However, the selection from one or more driving waveform candidates with which the ejection characteristic indicated by the first information satisfies the first condition and the ejection characteristic by the second information satisfies the second condition from among the plurality of driving waveform candidates may be automatically made. For example, the driving waveform candidate having the smallest or largest estimated value defined based on the first information and the second information can be selected as the driving waveform applied to the liquid ejecting apparatus.

### G6. Further Embodiment 6

In the third embodiment, among the driving waveform candidates Wci that satisfy the first condition and the second condition, the driving waveform candidates Wci having the smaller difference between the ejection characteristic indicated by the first information Ic1 and the ejection characteristic indicated by the second information Ic2 than the predetermined reference is determined as the driving waveform W (refer to S34b in FIG. 7). However, among the driving waveform candidates Wci that satisfy the first condition and the second condition, the driving waveform candidate Wci having the smallest difference between the ejection characteristic indicated by the first information Ic1 and the ejection characteristic indicated by the second information Ic2 may be automatically determined as the driving waveform W. In addition, as in the first embodiment, the driving waveform W may be defined without consideration of the difference between the ejection characteristic indicated by the first information Ic1 and the ejection characteristic indicated by the second information Ic2.

### G7. Further Embodiment 7

According to the first embodiment, the ejection characteristic to be considered in determining the driving waveform is the ejection amount of the liquid ejected from one nozzle of the ink ejecting head 41 by the ejecting operation of the driving elements PZT (refer to S13 and 23 in FIG. 5). As a result, the driving waveform having a small deviation in ejection amount between liquids ejected from the nozzles is determined. However, the ejection characteristic to be considered in determining the driving waveform may be any other characteristic.

For example, the ejection characteristic may be the ejection speed of the liquid ejected from the nozzle of the liquid ejecting head. With such aspect, even when environmental conditions vary, the driving waveform that hardly changes the ejection speed of the liquid ejected from the nozzles can be determined.

With such aspect, Dva that is the first deviation information Id1 is calculated as follows:

Dva=|Pvt−Pva| . . . (6)

Pvt is an ideal ejection speed.

Pva is the ejection speed indicated by the first information Ic1, which is the ejection speed when a certain driving waveform candidate Wci is applied to the printer 1.

Dvb that is the second deviation information Id2 is calculated as follows:

Dvb=|Pvt−Pvb| . . . (7)

Pvb is the ejection speed indicated by the second information Ic2, which is the ejection speed when a certain driving waveform candidate Wci is applied to the printer 1.

An estimated value DPv that is the third information Ic3 is calculated as follows:

DPv=|Pvb−Pva| . . . (8)

### G8. Further Embodiment 8

(1) The ejection characteristic may be the total amount of sub-droplets (so-called satellite) ejected from one nozzle Nz of the ink ejecting head 41 by the ejecting operation of the driving elements PZT. With such aspect, the driving waveform having a small amount of sub-droplets ejected from the nozzles can be determined.

(2) The ejection characteristic may be defined using two or more parameters selected from a plurality of characteristic parameters such as ejection amount, ejection speed, and the total amount of sub-droplets.

### G9. Further Embodiment 9

(1) According to the sixth embodiment, the shape of an ink flow channel from outside to the ink ejecting head 41a in the first head unit 40a differs from the shape of an ink flow channel from outside to the ink ejecting head 41b in the second head unit 40b. However, an object to which the method in any of the sixth embodiment and its modification examples is applied may be the liquid ejecting devices having configurations, such as nozzle diameter, different from each other. When two liquid ejecting devices differ from each other in at least one of inertance, compliance, and resistance, it can be said that the two liquid ejecting devices have configurations different from each other. The object to which the sixth embodiment is applied may be the liquid ejecting devices having the same driving element.

(2) Both aspects described in the sixth embodiment and the modification example may be combined with any of the aspects of the first to fifth embodiments.

### G10. Further Embodiment 10

In the fifth embodiment, the determining processing selected in Step S520 in FIG. 9, that is, the first determining processing or the second determining processing, is executed in Step S530 or Step S540. However, as in the first embodiment, the first determining processing may be executed without the user's selection. In addition, after both the first determining processing and the second determining processing are executed, the ejection characteristic of the driving waveform determined in the first determining processing and the ejection characteristic of the driving waveform determined in the second determining processing may be output to prompt the user's selection.

### H. Still Further Embodiment

The present disclosure is not limited to the above-described embodiments, and may be realized as various embodiments so as not to deviate from the subject matter. For example, the present disclosure can be realized as following embodiments. In order to resolve some or all problems of the present disclosure or achieve some or all effects of the present disclosure, the technical features in the above-mentioned embodiments, which correspond to technical features in each of below-mentioned embodiments can be appropriately replaced or combined. In addition, when the technical feature is not described as being essential in this specification, it can be omitted as appropriate.

(1) An embodiment of the present disclosure may provide the method of determining the driving waveform of the driving signal applied to the driving elements of the liquid ejecting device in order to eject a liquid from the liquid ejecting device. This method includes: a first acquiring step of executing first acquisition processing of acquiring first information about an ejection characteristic of a first liquid ejected from the liquid ejecting device when each of a plurality of driving waveform candidates is applied to the driving element; a second acquiring step of executing second acquisition processing of acquiring second information about an ejection characteristic of a second liquid ejected from the liquid ejecting device when each of the plurality of driving waveform candidates is applied to the driving element, the second liquid differing from the first liquid; and a waveform determining step of determining, based on the first information and the second information, the driving waveform.

With such aspect, the driving waveform achieving the desirable ejection characteristic for both the first liquid and the second liquid can be determined.

(2) In the above-described embodiment, the waveform determining step may include determining whether or not the ejection characteristic indicated by the first information satisfies a first condition, and determining whether or not the ejection characteristic indicated by the second information satisfies a second condition.

With such aspect, by appropriately defining the first condition and the second condition, the driving waveform achieving the desirable ejection characteristic for each of the first liquid and the second liquid can be determined.

(3) In the above-described embodiment, the first condition may be that a value expressed by the ejection characteristic of the first liquid falls within a first range, and the second condition may be that a value expressed by the ejection characteristic of the second liquid falls within a second range.

With such aspect, by appropriately defining the first range and the second range, the driving waveform achieving the desirable ejection characteristic for each of the first liquid and the second liquid can be determined.

(4) In the above-described embodiment, this method may further include accepting an input of the first range and accepting an input of the second range.

With such aspect, the user can appropriately define the first condition and the second condition to determine the driving waveform achieving the desirable ejection characteristic for each of the first liquid and the second liquid.

(5) In the above-described embodiment, the waveform determining step may include accepting an input of selection from one or more driving waveform candidates with which the ejection characteristic indicated by the first information satisfies the first condition and the ejection characteristic indicated by the second information satisfies the second condition, from among the plurality of driving waveform candidates.

With such aspect, the user's intention about the ejection characteristic of the first liquid and the ejection characteristic of the second liquid can be reflected to determine the driving waveform (W).

(6) In the above-described embodiment, the waveform determining step may be determining, as the driving waveform, a driving waveform candidate having a smaller difference between the ejection characteristic indicated by the first information and the ejection characteristic indicated by the second information than a reference from among the plurality of driving waveform candidates.

With such aspect, the driving waveform having a small difference between the ejection characteristic of the first liquid and the ejection characteristic of the second liquid can be determined. Thus, when the first liquid and the second liquid are equally used, the quality of the generated product can be improved.

(7) In the above-described embodiment, the ejection characteristic may be an ejection amount of the liquid ejected by an ejecting operation of the driving element.

With such aspect, the driving waveform having a small difference in ejection amount between liquids ejected from the nozzles can be determined.

(8) In the above-described embodiment, the ejection characteristic may be an ejection speed of the liquid ejected from the liquid ejecting device.

With such aspect, the driving waveform having a small variation in ejection speed of the liquid ejected from the nozzles can be determined.

(9) Another embodiment of the present disclosure may provide the method of determining a common driving waveform of a driving signal applied to each of a first driving element of a first liquid ejecting device and a second driving element of a second liquid ejecting device, the first liquid ejecting device and the second liquid ejecting device having configurations different from each other, in order to eject a liquid from each of the first liquid ejecting device and the second liquid ejecting device. This method includes: a first acquiring step of executing first acquisition processing of acquiring first information about an ejection characteristic of the liquid ejected from the first liquid ejecting device when each of a plurality of driving waveform candidates is applied to the first driving element; a second acquiring step of executing second acquisition processing of acquiring second information about the ejection characteristic of the liquid ejected from the second liquid ejecting device when each of the plurality of driving waveform candidates is applied to the second driving element; and a waveform determining step of determining, based on the first information and the second information, the common driving waveform.

With such aspect, the driving waveform achieving the desirable ejection characteristic for both the first liquid ejecting device and the second liquid ejecting device can be determined.

(10) In the above-described embodiment, the waveform determining step may include determining whether or not the ejection characteristic indicated by the first information satisfies a first condition, and determining whether or not the ejection characteristic indicated by the second information satisfies a second condition.

With such aspect, by appropriately defining the first condition and the second condition, the driving waveform achieving the desirable ejection characteristic for each of the first liquid and the second liquid can be determined.

(11) In the above-described embodiment, the first condition may be that a value expressed by the ejection characteristic of the liquid falls within a first range, and the second condition may be that a value expressed by the ejection characteristic of the liquid falls within a second range.

With such aspect, by appropriately defining the first range and the second range, the driving waveform achieving the desirable ejection characteristic for each of the first liquid and the second liquid can be determined.

(12) In the above-described embodiment, this method may further include accepting an input of the first range and accepting an input of the second range.

With such aspect, the user's intention about the first liquid and the second liquid can be reflected to determine the driving waveform.

(13) In the above-described embodiment, the waveform determining step may include accepting an input of selection from one or more driving waveform candidates with which the ejection characteristic indicated by the first information satisfies the first condition and the ejection characteristic indicated by the second information satisfies the second condition, from among the plurality of driving waveform candidates.

With such aspect, by appropriately defining the first condition and the second condition, the driving waveform achieving the desirable ejection characteristic for each of the first liquid and the second liquid can be determined.

(14) In the above-described embodiment, the waveform determining step may be determining, as the driving waveform, the driving waveform candidate having a smaller difference between the ejection characteristic indicated by the first information and the ejection characteristic indicated by the second information than a reference from among the plurality of driving waveform candidates.

With such aspect, the driving waveform having a small difference between the ejection characteristic of the first liquid and the ejection characteristic of the second liquid can be determined. Thus, when the first liquid and the second liquid are equally used, the quality of the generated product can be improved.

(15) In the above-described embodiment, the ejection characteristic may be an ejection amount of the liquid ejected by an ejecting operation of the first driving element or the second driving element.

With such aspect, the driving waveform having a small variation in ejection amount of the liquid ejected from the nozzles can be determined.

(16) In the above-described embodiment, the ejection characteristic may be an ejection speed of the liquid ejected from the first liquid ejecting device or the second liquid ejecting device.

With such aspect, the driving waveform having a small variation in ejection speed of the liquid ejected from the nozzles can be determined.

(17) Another embodiment of the present disclosure may provide a non-transitory computer-readable storage medium storing a computer program, the computer program causing a computer to perform the driving waveform determining method according to any one of the above-described embodiments (1) to (16).

(18) Another embodiment of the present disclosure may provide a liquid ejecting apparatus. This apparatus includes: a first characteristic acquiring section configured to execute first acquisition processing of acquiring first information about an ejection characteristic of a first liquid ejected from the liquid ejecting device when each of a plurality of driving waveform candidates is applied to the driving element; a second characteristic acquiring section configured to execute second acquisition processing of acquiring second information about the ejection characteristic of a second liquid ejected from the liquid ejecting device when each of the plurality of driving waveform candidates is applied to the driving element, the second liquid differing from the first liquid; and a waveform determining section that determines, based on the first information and the second information, a driving waveform.

(19) In the above-described embodiment, the waveform determining section may be configured to execute second determining processing of determining, based on the second information and at least a part of the plurality of driving waveform candidates, not based on the first information, the driving waveform, the liquid ejecting apparatus may further include an accepting section that accepts selection of either the first determining processing or the second determining processing, and the waveform determining section may execute determining processing selected between the first determining processing and the second determining processing.

From such aspect, when it is preferred to determine the driving waveform optimized for the second liquid, the user can select the second determining processing to cause the driving waveform determining apparatus to execute the second determining processing. As a result, the driving waveform optimized for the second liquid is determined.

(20) Another embodiment of the present disclosure may provide a liquid ejecting apparatus. This apparatus includes: a first liquid ejecting device having a first driving element driven by application of a driving signal, the first liquid ejecting device ejecting a liquid by driving of the first driving element; a second liquid ejecting device having a second driving element driven by application of the driving signal, the second liquid ejecting device ejecting a liquid ejected by driving of the second driving element and differing from the first liquid ejecting device in configuration; a driving control section that controls the first liquid ejecting device and the second liquid ejecting device; a first characteristic acquiring section that executes first acquisition processing of acquiring first information about an ejection characteristic of the liquid ejected from the first liquid ejecting device when each of a plurality of driving waveform candidates is applied to the driving element; a second characteristic acquiring section that executes second acquisition processing of acquiring second information about an ejection characteristic of the liquid ejected from the second liquid ejecting device when each of the plurality of driving waveform candidates is applied to the second driving element; and a waveform determining section that determines, based on the first information and the second information, a common driving waveform of the driving signal applied to the first driving element of the first liquid ejecting device and the driving signal applied to the second driving element of the second liquid ejecting device.

(21) In the above-described embodiment, the waveform determining section may execute second determining processing of determining, based on the second information and at least a part of the plurality of driving waveform candidates, not based on the first information, the driving waveform, the liquid ejecting apparatus may include an accepting section that accepts selection of either the first determining processing or the second determining processing, and the waveform determining section may execute the selected determining processing between the first determining processing and the second determining processing.

From such aspect, when it is preferred to determine the driving waveform optimized for the second liquid ejecting device, the user can select the second determining processing to cause the driving waveform determining apparatus to execute the second determining processing. As a result, the driving waveform optimized for the second liquid ejecting device is determined.

The present disclosure can be embodied as various forms other than the driving waveform determining method, the liquid ejecting apparatus, and the computer program that performs the driving waveform determining method. For example, the present disclosure can be embodied as a liquid ejecting apparatus control method, a computer program that implements the control method, and a non-temporary recording medium. In addition, although the printer 1 has been described in the embodiments, a printer may not be used in the liquid ejecting apparatus, and a so-called experiment apparatus or estimating apparatus may be instead used as long as it has a function of ejecting liquid.

What is claimed is:

1. A driving waveform determining method of determining a driving waveform of a driving signal applied to a driving element of a liquid ejecting device, in order to eject a liquid from the liquid ejecting device, the method comprising:
a first acquiring step of executing first acquisition processing of acquiring first information about an ejection characteristic of a first liquid ejected from the liquid ejecting device when each of a plurality of driving waveform candidates is applied to the driving element;
a second acquiring step of executing second acquisition processing of acquiring second information about an ejection characteristic of a second liquid ejected from the liquid ejecting device when each of the plurality of driving waveform candidates is applied to the driving element, the second liquid differing from the first liquid; and
a waveform determining step of determining, based on the first information and the second information, the driving waveform.

2. The driving waveform determining method according to claim 1, wherein
the waveform determining step includes
determining whether or not the ejection characteristic indicated by the first information satisfies a first condition and
determining whether or not the ejection characteristic indicated by the second information satisfies a second condition.

3. The driving waveform determining method according to claim 2, wherein
the first condition is that a value expressed by the ejection characteristic of the first liquid falls within a first range, and
the second condition is that a value expressed by the ejection characteristic of the second liquid falls within a second range.

4. The driving waveform determining method according to claim 3, further comprising:
accepting an input of the first range; and
accepting an input of the second range.

5. The driving waveform determining method according to claim 2, wherein
the waveform determining step includes accepting an input of selection from one or more driving waveform candidates with which the ejection characteristic indicated by the first information satisfies the first condition and the ejection characteristic indicated by the second information satisfies the second condition, from among the plurality of driving waveform candidates.

6. The driving waveform determining method according to claim 1, wherein
the waveform determining step is determining, as the driving waveform, a driving waveform candidate having a smaller difference between the ejection characteristic indicated by the first information and the ejection characteristic indicated by the second information than a reference from among the plurality of driving waveform candidates.

7. The driving waveform determining method according to claim 1, wherein
the ejection characteristic is an ejection amount of the liquid ejected by an ejecting operation of the driving element.

8. The driving waveform determining method according to claim 1, wherein
the ejection characteristic is an ejection speed of the liquid ejected from the liquid ejecting device.

9. A driving waveform determining method of determining a common driving waveform of a driving signal applied to each of a first driving element of a first liquid ejecting device and a second driving element of a second liquid ejecting device, the first liquid ejecting device and the second liquid ejecting device having configurations different from each other, in order to eject a liquid from each of the first liquid ejecting device and the second liquid ejecting device, the method comprising:
a first acquiring step of executing first acquisition processing of acquiring first information about an ejection characteristic of the liquid ejected from the first liquid ejecting device when each of a plurality of driving waveform candidates is applied to the first driving element;
a second acquiring step of executing second acquisition processing of acquiring second information about the ejection characteristic of the liquid ejected from the second liquid ejecting device when each of the plurality of driving waveform candidates is applied to the second driving element; and
a waveform determining step of determining, based on the first information and the second information, the common driving waveform.

10. The driving waveform determining method according to claim 9, wherein
the waveform determining step includes
determining whether or not the ejection characteristic indicated by the first information satisfies a first condition and
determining whether or not the ejection characteristic indicated by the second information satisfies a second condition.

11. The driving waveform determining method according to claim 10, wherein
the first condition is that a value expressed by the ejection characteristic of the liquid falls within a first range, and
the second condition is that a value expressed by the ejection characteristic of the liquid falls within a second range.

12. The driving waveform determining method according to claim 11, further comprising:
accepting an input of the first range; and
accepting an input of the second range.

13. The driving waveform determining method according to claim 10, wherein
the waveform determining step includes accepting an input of selection from one or more driving waveform candidates with which the ejection characteristic indicated by the first information satisfies the first condition and the ejection characteristic indicated by the second information satisfies the second condition, from among the plurality of driving waveform candidates.

14. The driving waveform determining method according to claim 13, wherein
the waveform determining step is determining, as the driving waveform, a driving waveform candidate having a smaller difference between the ejection characteristic indicated by the first information and the ejection characteristic indicated by the second information than a reference from among the plurality of driving waveform candidates.

15. The driving waveform determining method according to claim 9, wherein
the ejection characteristic is an ejection amount of the liquid ejected by an ejecting operation of the first driving element or the second driving element.

16. The driving waveform determining method according to claim 9, wherein
the ejection characteristic is an ejection speed of the liquid ejected from the first liquid ejecting device or the second liquid ejecting device.

17. A non-transitory computer-readable storage medium storing a computer program, the computer program causing a computer to perform the driving waveform determining method according to claim 1.

18. A liquid ejecting apparatus comprising:
a liquid ejecting device including a driving element driven at application of a driving signal, the liquid ejecting device ejecting a liquid by driving of the driving element;
a driving control section that controls the liquid ejecting device;
a first characteristic acquiring section configured to execute first acquisition processing of acquiring first information about an ejection characteristic of a first liquid ejected from the liquid ejecting device when each of a plurality of driving waveform candidates is applied to the driving element;
a second characteristic acquiring section configured to execute second acquisition processing of acquiring second information about the ejection characteristic of a second liquid ejected from the liquid ejecting device when each of the plurality of driving waveform candidates is applied to the driving element, the second liquid differing from the first liquid; and
a waveform determining section that executes first determining processing of determining, based on the first information and the second information, a driving waveform.

19. The liquid ejecting apparatus according to claim 18, wherein
the waveform determining section is configured to execute second determining processing of determining, based on the second information and at least a part of the plurality of driving waveform candidates, not based on the first information, the driving waveform,
the liquid ejecting apparatus further comprises an accepting section that accepts selection of either the first determining processing or the second determining processing, and
the waveform determining section executes determining processing selected between the first determining processing and the second determining processing.
